(19) United States
(12) Patent Application Publication
(10) Pub. No.: US 2026/0200547 A1
(43) Pub. Date: Jul. 16, 2026

(54) COLLAPSIBLE SCOOTER WITH ROTATABLE DECK FOR COMPACT PACKAGING AND ASSOCIATED METHODS

(71) Applicant: Huffy Corporation, Miamisburg, OH (US)

(72) Inventor: Donald K. Jessie, JR., Middletown, OH (US)

(21) Appl. No.: 19/020,371

(22) Filed: Jan. 14, 2025

(51) Int. Cl. B62K 3/00; B62K 15/00

(52) U.S. Cl. CPC B62K 3/002; B62K 15/006

(57) ABSTRACT

A scooter including a front frame assembly rotatable relative to a rear frame assembly is provided. The front frame assembly includes a handlebar connected to a steering tube that includes a front wheel supported by a front fork. The rear frame assembly includes a neck assembly with a head tube. The steering tube is rotatably coupled to the head tube to define a steering axis about which the front frame rotates relative to the rear frame. The rear frame assembly includes a rear wheel assembly with a rear wheel supported by a rear fork and a deck tube that extends a length from the rear fork to a terminal end. The terminal end of the deck tube is attached to the neck assembly. The rear frame assembly includes a deck supported by the deck tube. The deck is selectively rotatable about the deck tube between at least an operative position wherein the deck is configured to support a rider and a stowed position.

### TECHNICAL FIELD

The present invention relates generally to child vehicles, and more particularly to kick scooters and methods of packaging same.

### BACKGROUND

Scooters are among the most popular outdoor toys for children and young adults. One common type of scooter is the kick scooter, which is propelled by the rider pushing off the ground with one foot. Traditionally, scooters are manufactured and shipped to retail outlets, where they are offered to end consumers. However, with the rise of online shopping, consumers increasingly purchase scooters directly from manufacturers or online retailers.

Manufacturers aim to package scooters in a way that is both efficient and cost-effective. This often involves shipping scooters in a partially or fully unassembled state to reduce packaging size and shipping costs. For example, components such as wheels, handlebars, decks, or other features may be packaged separately and require assembly before use. While some retail outlets may offer assembly services, the responsibility for assembly frequently falls on the end consumer. As a result, manufacturers face the challenge of providing scooters in an assembled or near-assembled configuration to minimize the consumer's assembly effort, while simultaneously balancing the need to reduce packaging size and shipping costs.

In view of the above, an object of the invention is to provide a scooter that can be packaged in a compact and cost-efficient manner while minimizing the amount of assembly required by the end consumer. It is also an object of the invention to provide a scooter with reduced part sizes to minimize material usage, thereby lowering manufacturing costs and shipping expenses, without compromising performance and safety of the scooter.

### SUMMARY

According to an aspect of the present invention a scooter including a front frame assembly rotatable relative to a rear frame assembly is disclosed. The front frame assembly includes a handlebar connected to a steering tube that includes a front wheel supported by a front fork. The rear frame assembly includes a neck assembly with a head tube. The steering tube of the front frame assembly is rotatably coupled to the head tube to define a steering axis about which the front frame rotates relative to the rear frame. The rear frame assembly includes a rear wheel assembly with a rear wheel supported by a rear fork and a deck tube that extends a length from the rear fork to a terminal end. The terminal end of the deck tube is attached to the neck assembly. The rear frame assembly further includes a deck supported by the deck tube. The deck is selectively rotatable about the deck tube between at least an operative position wherein the deck is configured to support a rider and a stowed position.

According to one embodiment of the present invention, the deck includes a support surface that is configured to receive the rider. The support surface may define a support surface plane. The support surface plane may be horizontal when the deck is rotated to the operative position and non-horizontal when the deck is rotated to the stowed position. In another embodiment, the deck may be secured in the operative position with one or more fasteners received through the deck and the deck tube. In that regard, the deck tube may extend along a length of the deck, for example. In one embodiment, the deck tube may include a circular cross-sectional profile.

In one embodiment of the present invention, the deck may extend a length between a first end and an opposite second end. The deck may further include including a channel that extends from an opening at the first end of the deck to an opening at the second end of the deck through which the deck tube may be received. For example, the channel may define a bore through the deck.

In another embodiment of the present invention, the head tube of the neck assembly may be arranged externally along a sidewall of the steering tube. For example, the steering tube defines a steering tube axis, and the steering tube axis may be offset from the steering axis. In one embodiment, the steering axis may be located outside the steering tube.

In one embodiment, the neck assembly may be selectively foldable about a hinge joint to place the scooter in at least an upright position, where the steering tube is approximately perpendicular to the deck tube, and a collapsed position, where the steering tube is approximately parallel to the deck tube. In another embodiment, the deck may be selectively rotatable to the stowed position when the scooter is in the collapsed position.

According to another aspect of the present invention, a method for packaging a scooter is disclosed. The method includes providing a carton and a scooter. The scooter includes a front frame assembly having a handlebar, a steering tube, and a front wheel supported by a front fork. The rear frame assembly includes a neck assembly operatively coupled to the front frame assembly such that the front frame assembly is rotatable about a steering axis relative to the rear frame assembly. The assembly is selectively foldable about a hinge joint. The rear frame assembly includes a rear wheel assembly having a rear wheel supported by a rear fork and a deck tube that extends a length from the rear fork to a terminal end. The terminal end of the deck tube is attached to the neck assembly. The rear frame assembly further includes a deck supported by the deck tube such that the deck is rotatable relative to the deck tube. The method includes assembling the scooter into a packaged configuration which includes the steps of folding the scooter at the hinge joint to place the scooter in a collapsed position and rotating the deck about the deck tube to place the deck in a stowed position. The method further includes inserting the scooter into the carton once the scooter is assembled to the packaged configuration.

According to one embodiment, the steering tube may be approximately parallel to the deck tube when the scooter is in the packaged configuration. In another embodiment, the deck may extend a width between a pair of side edges that extend along a length of the deck. In that regard, when the scooter is in the packaged configuration, at least one of the pair of side edges is disposed in a space between the steering tube and the deck tube.

According to another embodiment, the step of assembling the scooter into the packaged configuration further includes placing the handlebar in a space between the steering tube and the deck of the scooter. In one embodiment, the deck may extend a width between a pair of side edges that extend along a length of the deck. In that regard, when the scooter is in the packaged configuration, the handlebar is arranged between at least one of the pair of side edges and the steering tube.

According to yet another embodiment, the method further includes attaching the scooter to a backing panel such that the scooter is maintained in the packaged configuration by the backing panel, and inserting the backing panel and the scooter into the carton. For example, the deck may include a support surface that is configured to receive the rider, and the support surface may define a support surface plane. The support surface plane may be approximately parallel to a plane defined by the backing panel when the scooter is attached to the backing panel. In one embodiment, the carton may be a peggable carton.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a perspective view of a collapsible scooter having a rotatable deck in accordance with an embodiment of the present invention.

FIG. 2 is a partial disassembled perspective view of the scooter of FIG. 1.

FIG. 3 is a cross-sectional view of the scooter of FIGS. 1 and 2.

FIG. 4 is an enlarged cross-sectional view of the neck assembly of the scooter of FIGS. 1-3.

FIG. 5 is a diagrammatic view of a rear frame assembly of the scooter of FIGS. 1-4, illustrating the deck rotated to a stowed position.

FIG. 6 is a view similar to FIG. 5, illustrating the deck rotated to an operative position.

FIG. 7 is a plan view of the scooter folded to a collapsed position with the deck rotated to the stowed position, illustrating certain carton dimensions for packaging the scooter.

FIG. 8 is a view similar to FIG. 7, with the scooter folded to a collapsed position with the deck rotated to the operative position, illustrating certain carton dimensions for packaging the scooter.

FIG. 9 is a side view of the scooter in a packaged configuration with the scooter folded to a collapsed position and the deck rotated to the stowed position.

### DETAILED DESCRIPTION

Embodiments of the present invention are directed to a collapsible scooter with a rotatable deck that provides for compact packaging solutions. The scooter is configured to fold at a hinge joint, collapsing the front frame relative to the rear frame. Additionally, the deck of the scooter is configured to rotate from a horizontal (operative) position to a vertical (stowed) position. The scooter is configured to be arranged in a packaged configuration, where the scooter is folded into the collapsed position with the deck rotated to the stowed position. The packaged configuration offers significant advantages in terms of space-efficient packaging, providing for up to a 40% reduction, or more, in the width or depth dimension of the carton used for packaging the scooter. As a result, the carton in which the scooter is packaged and sold requires less shelf space for retail display purposes, and may be configured as a peggable carton, for example. These and other benefits of the present invention will be further detailed in the following description.

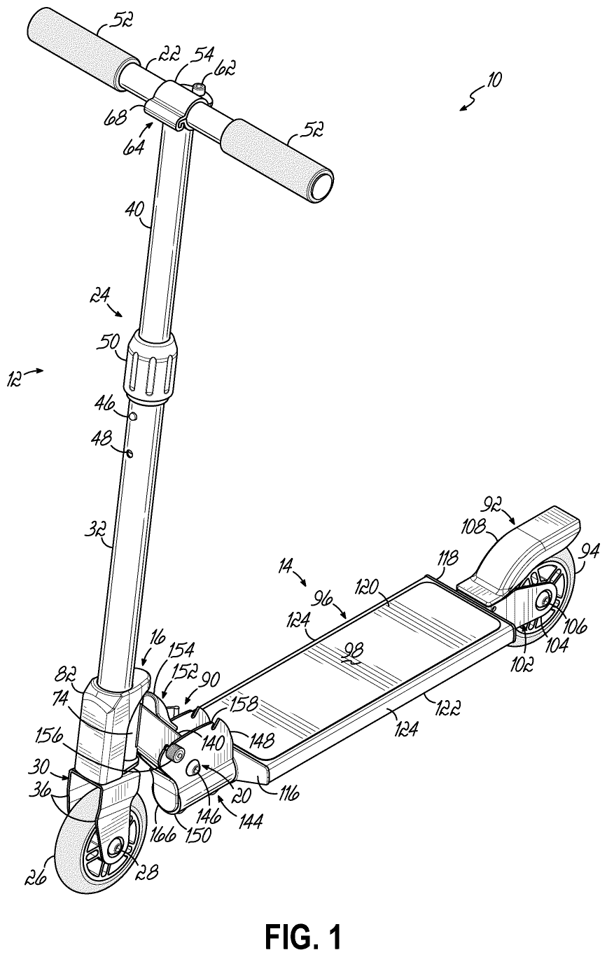

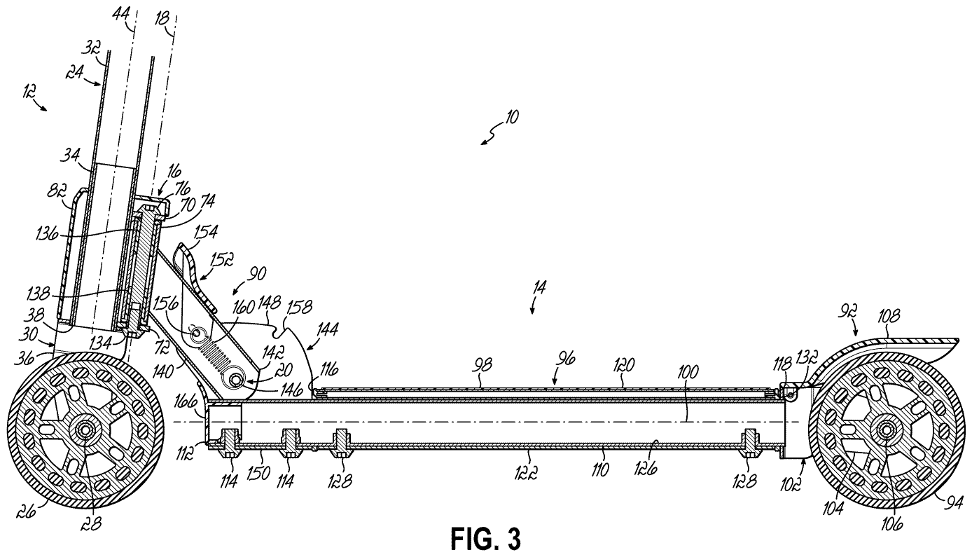

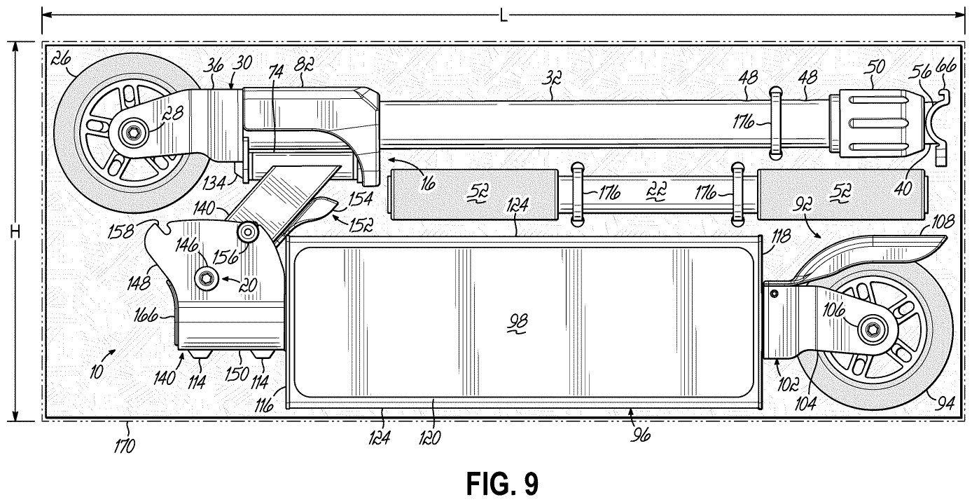

Referring now to the figures, FIG. 1 illustrates a scooter 10 in accordance with aspects of the present invention. The exemplary scooter 10 is a two-wheeled kick scooter 10; however, aspects of the present invention are not limited to two-wheeled kick scooters 10 and broadly apply to various scooters and child vehicles generally, including those with more wheels or powered scooters, for example. The scooter 10 includes a front frame assembly (“front frame”) 12 rotatably coupled to a rear frame assembly (“rear frame”) 14 at a joint 16. The joint 16 permits the front frame 12 to rotate relative to the rear frame 14 for steering the scooter 10, for example. To that end, the joint 16 defines a steering axis 18 of the scooter 10 (e.g., FIG. 3). The exemplary scooter 10 is a collapsible scooter 10, meaning that the scooter 10 is selectively foldable at a hinge joint 20 between at least two positions: an upright, operational position (e.g., FIG. 1) for riding, and a compact, collapsed position (e.g., FIG. 9) for storage and/or packaging.

For clarity, the terms “front” and “rear” are directional terms in reference the scooter 10 and in particular a rider operating the scooter 10. Specifically, “front” refers to the forward-facing direction or portion of the scooter 10, corresponding to the direction the rider faces while standing or riding on the scooter 10. Conversely, “rear” refers to the back portion of the scooter 10, corresponding to the direction behind the rider.

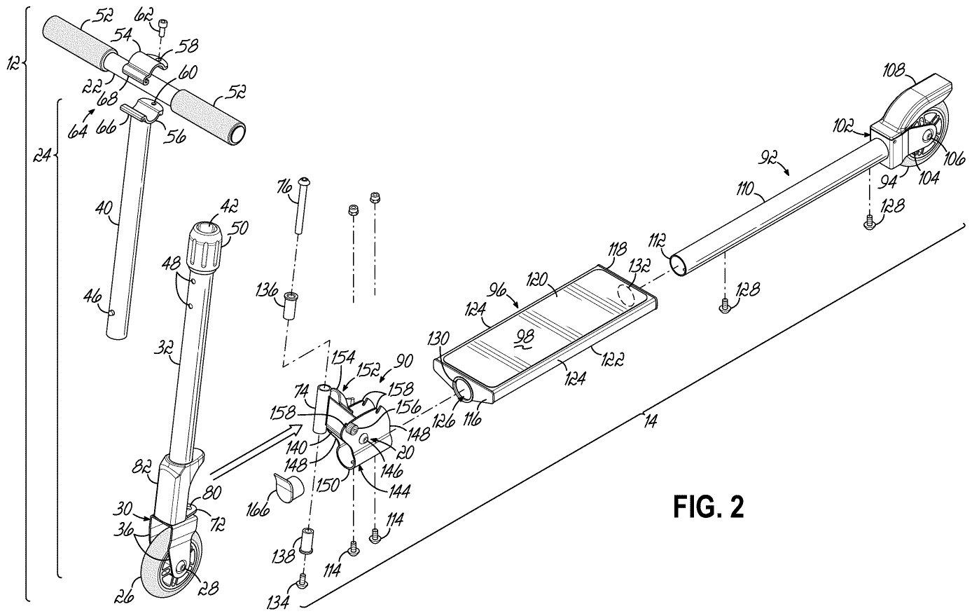

Referring now to FIGS. 1 and 2, the front frame 12 includes a handlebar 22 that is removably attachable to a steering column 24 of the scooter 10. The handlebar 22 is used to rotate the steering column 24 to steer a front wheel 26 of the scooter 10. The front wheel 26, supported by an axle 28, is mounted on a front fork 30 that is coupled to a steering tube 32 of the steering column 24. The front fork 30 includes a fork stem 34 and a pair of spaced apart forks or legs 36 extending therefrom in a generally parallel fashion. As shown in FIG. 3, the fork stem 34 of the front fork 30 is inserted into a lower end 38 of the steering tube 32 for attachment thereto. The front wheel 26 is positioned between the forks 36 of the front fork 30 and rotatably coupled to the front axle 28 to allow rotation of the front wheel 26 relative to the front frame 12.

In the embodiment shown, the steering column 24 is a telescoping steering column 24 to allow adjustment of a height of the handlebar 22 of the scooter 10 to accommodate riders of different sizes. In that regard, the steering column 24 includes the steering tube 32 and a handlebar tube or stem 40 that is configured to be telescopically received into an upper end 42 of the steering tube 32. The handlebar stem 40 is configured to telescopically slide in and out of the steering tube 32 in a direction along a steering tube axis 44 of the steering tube 32 and steering column 24. To secure the handlebar stem 40 at a desired position relative to the steering tube 32, the handlebar stem 40 includes a push button 46 that is configured to fit through one or more apertures 48 spaced along the steering tube 32. The engagement between the push button 46 and each aperture 48 prevents movement of the handlebar stem 40 relative to the steering tube 32, and further allows for selective adjustment of a height of the steering column 24 (i.e., a handlebar 22 height). Additionally, the steering tube 32 may include a collar clamp 50 to lock the handlebar stem 40 in place, ensuring no relative movement between the handlebar stem 40 and the steering column 24 while the scooter 10 is in use.

With continued reference to FIGS. 1 and 2, the handlebar 22 includes a pair of grips 52, with one grip 52 being located at each end of the handlebar 22. The pair of grips 52 are configured to be gripped by a user to steer the scooter 10. To facilitate packaging of the scooter 10, as will be described in further detail below, the handlebar 22 is configured to be removably attached to the handlebar stem 40 with a bracket 54. In that regard, the handlebar stem 40 includes a seat 56 that is configured to receive the handlebar 22. The seat 56 includes an arcuate surface that is curved in a direction between a front side and a rear side of the seat 56. The arcuate surface of the seat 56 is configured to cradle the handlebar 22, and the arcuate surface may extend for up to about 50% about a circumference of the handlebar 22, for example. As used herein, “about” or “approximately” means +/−10%. Once the handlebar 22 is received in the seat 56, the bracket 54 fits over the top of the handlebar 22 and is configured to be fastened to the seat 56, thereby clamping the handlebar 22 firmly between the seat 56 and the bracket 54. Like the seat 56, the bracket 54 also includes an arcuate surface that is configured to engage the handlebar 22. The arcuate surface of the bracket 54 is configured to cover a portion of the handlebar 22 and may extend for up to about 50% about the circumference of the handlebar 22, for example. The bracket 54 may be referred to as a collar clamp or saddle clamp, for example.

With continued reference to FIGS. 1 and 2, the bracket 54 and the seat 56 each include a tab with an aperture, 58, 60, respectively. Each tab extends from a respective rear-facing side of the bracket 54 and the seat 56. Once aligned, the apertures 58,60 are configured to receive a fastener 62, such as a screw or bolt, for coupling the bracket 54 to the seat 56 to secure the handlebar 22 therebetween. On the front-facing side, the bracket 54 and the seat 56 are joined by an interlocking joint 64. The interlocking joint 64 is defined by the engagement between an elongate hook 66 of the seat 56 that fits into a corresponding elongate channel 68 on the bracket 54. The interlocking engagement between the hook 66 and channel 68 provides a tool-less yet secure connection between the bracket 54 and the seat 56 on the front side of the handlebar 22. The connection between the bracket 54 and the seat 56 may be made at the interlocking joint 64 first, followed by lowering the bracket 54 down over the handlebar 22. After which, only a single fastener 62 is needed to secure the bracket 54 to the seat 56 on the rear-facing side of the handlebar 22 for easy assembly. However, in an alternative embodiment, more than one fastener 62 may be used, and the bracket 54 may be fastened to the seat 56 on either side of the handlebar 22 with a fastener 62.

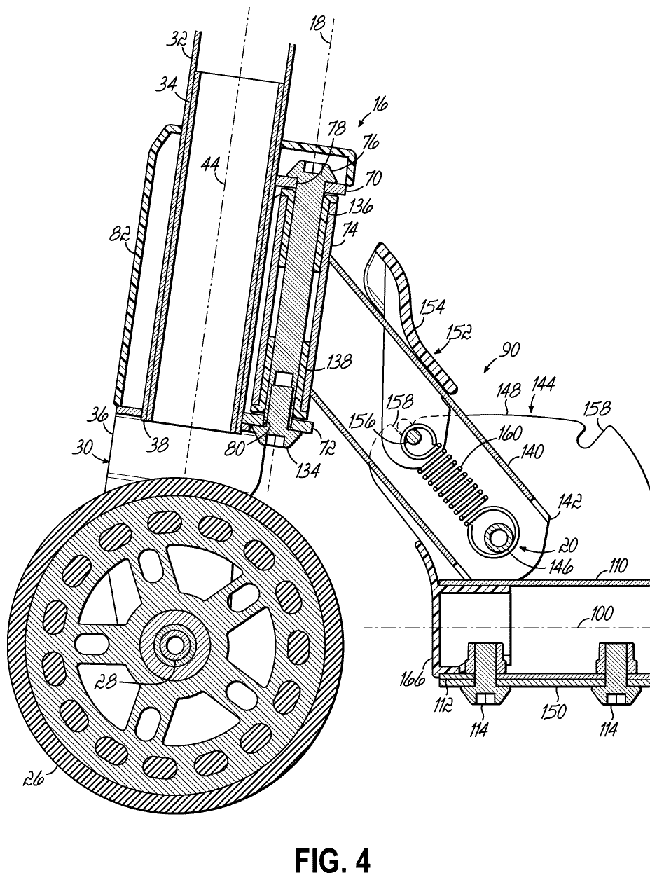

As briefly described above, the rear frame 14 is connected to the front frame 12 at the pivot joint 16 where the front frame 12 is able to rotate relative to the rear frame 14 for steering the scooter 10. As shown in FIGS. 1 and 2, the rear frame 14 is attached to the front frame 12 at the lower end 38 of the steering tube 32. As best shown in FIGS. 3 and 4, the steering tube 32 includes an upper tab 70 and a lower tab 72 that are spaced apart to receive a head tube 74 of the rear frame 14 for coupling therebetween. The upper and lower tabs 70, 72 are positioned externally along the sidewall of the steering tube 32, and each tab 70, 72 extends or projects from the steering tube 32 in a rearward direction. As will be described in greater detail below, a connector bolt 76 passes through an opening 78 in the upper tab 70, the head tube 74, and an opening 80 in the lower tab 72, thereby coupling the front frame 12 to the rear frame 14 at the pivot joint 16. As a result of this configuration, the steering tube axis 44 does not coincide with the steering axis 18 defined by the connector bolt 76 and the headtube 74. In other words, the steering tube axis 44 is offset or spaced from the steering axis 18. The steering axis 18 is located outside of the steering tube 32. This configuration allows the steering tube 32 to be constructed with much smaller dimensions compared to a conventional scooter design, where the steering tube 32 includes the head tube 74. For example, the steering tube 32 in the present invention may have a diameter of 16 millimeters (mm), whereas a conventional scooter design typically uses a 36 mm diameter steering tube 32. This reduction in size enables more space-efficient packaging of the scooter 10. The steering tube 32 may include a protective cover 82 that is configured to slide along the steering tube 32. The cover 82 is arranged to cover the lower end 38 of the steering tube 32, including at least the upper tab 70 and other components that form the joint 16, to protect those components from damage, dirt, and debris encountered during normal use of the scooter 10.

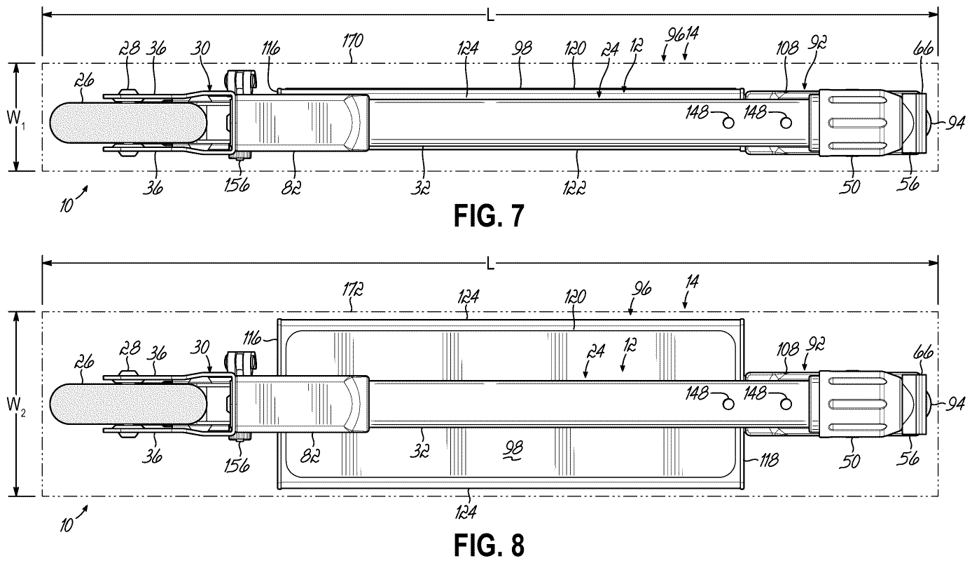

Referring again to FIGS. 1 and 2, the rear frame 14 of the scooter 10 includes a neck assembly 90 that includes the head tube 74 to which the front frame 12 assembly attaches, a rear wheel assembly 92 that operatively supports a rear wheel 94 and a deck 96 of the scooter 10. The deck 96 is configured to support the rider, such as by standing. In that regard, the deck 96 includes a support surface 98 that is configured to receive the rider, such as one or both feet of the rider. The deck 96 is selectively rotatable relative to the rear frame 14 about a deck axis 100. In particular, the deck 96 is rotatable about the deck axis 100 between at least two positions: an operative position, where the deck 96 is positioned to support a rider (e.g., FIG. 6), and a stowed position where the deck 96 is positioned for storage or packaging (e.g., FIG. 7).

With continued reference to FIGS. 1 and 2, the rear wheel assembly 92 of the rear frame 14 includes the rear wheel 94 that is supported by a rear fork 102. The rear fork 102 includes a pair of spaced apart forks or legs 104 extending therefrom in a generally parallel fashion. The rear wheel 94 is rotatably coupled between the forks 104 of the rear fork 102 with a rear axle 106 to allow rotation of the rear wheel 94 relative to the rear frame 14. The rear fork 102 includes a fender 108 that is hingeably attached to the rear fork 102 and extends outward over the rear wheel 94. The fender 108 serves as a splash guard as well as a brake for the scooter 10. The rear fork 102 further includes a fork stem, referred to hereafter as the deck tube 110, that extends a length from the rear fork 102 to a terminal end 112. The terminal end 112 of the deck tube 110 is configured to be attached to the neck assembly 90 of the rear frame 14 with one or more fasteners 114. In the embodiment shown, the terminal end 112 of the deck tube 110 is attached to the neck assembly 90 with a pair of fasteners 114. As described in further detail below, the deck 96 is supported by the deck tube 110, positioned between the rear wheel 94 and the neck assembly 90, and is rotatable about the deck tube 110 between at least the operative position and the stowed position. To that end, the deck tube 110 may define the deck axis 100 about which the deck 96 rotates. The deck axis 100 extends along a length of the deck 96 and may coincide with the axis of the deck tube 110.

With reference to FIGS. 1 and 2, the deck 96 extends a length between a first end 116 and an opposite second end 118, and includes a generally flattened top 120, opposite a base 122, the top 120 defining the support surface 98 on which the rider is configured to stand. The deck 96 also extends in width between a pair of side edges 124 that extend along the length of the deck 96 between the ends 116, 118. As shown, the length of the deck 96 is greater than the width of the deck 96. The deck 96 further includes a channel 126 that that is configured to receive the deck tube 110 therethrough. The deck 96 is rotatable about the deck tube 110 and may be secured in place relative to the deck tube 110 with one or more fasteners 128, ensuring that the deck 96 is affixed to the deck tube 110 to provide a stable platform for the rider to stand on. The fasteners 128 are received through the base 122 of the deck 96 and through apertures formed in the deck tube 110 at the underside of the scooter 10. The apertures may be internally threaded, for example. The fasteners 128 take the form of a wide variety of fasteners, including screws, bolts, spring pins, detent pins, and/or other tool or tool-less type of fasteners.

As best shown in FIGS. 2 and 3, the channel 126 extends from an opening 130 at the first end 116 of the deck 96 to an opening 132 at the second end 118 of the deck 96. The channel 126 may be formed in the body of the deck 96, between the base 122 and the top 120, as a tubular bore. As a result, when the deck tube 110 is inserted through the channel 126, the deck 96 is rotatably retained by the deck tube 110. The installation of the deck 96 onto the deck tube 110 may be reversible, meaning the deck tube 110 may be inserted into either opening 130, 132 to the channel 126 to install the deck 96 to the deck tube 110. In either case, the deck tube 110 is received through the openings 130, 132 so as to extend along the length of the deck 96, as shown in FIG. 3. By coupling the terminal end 112 of the deck tube 110 to the neck assembly 90 of the rear frame 14, the deck 96 is securely retained on the deck tube 110, positioned between the neck assembly 90 and the rear fork 102 (e.g., FIG. 3). In other words, the deck 96 cannot be removed from the deck tube 110 except by sliding the deck 96 off the terminal end 112 of the deck tube 110.

With continued reference to FIGS. 2 and 3, the neck assembly 90 of the rear frame 14 includes the head tube 74 and operatively couples the rear frame 14 of the scooter 10 to the front frame 12. In that regard, the head tube 74 is configured to receive the connector bolt 76 to couple the headtube 74 between the upper tab 70 and the lower tab 72 of the steering tube 32 of the front frame 12 to form the pivot joint 16, as described above. The connector bolt 76 may include a fastener 134 that is configured to be received into the end of the connector bolt 76 to couple the headtube 74 to the steering tube 32. The headtube 74 may include an upper headcup 136 and a lower headcup 138 to facilitate the rotation of the front frame 12 relative to the rear frame 14 at the pivot joint 16. The headcups 136, 138 may be in the form of bushings or bearings, for example.

As briefly described above, the neck assembly 90 also permits the selective folding of the scooter 10 about the hinge joint 20 to move the scooter 10 between at least an upright position (e.g., FIG. 1), where the steering tube 32 and steering tube axis 44 are about perpendicular to the deck tube 110 and the deck axis 100, and a collapsed position, where the steering tube 32 and steering tube axis 44 are about parallel to the deck tube 110 and the deck axis 100. In that regard, the neck assembly 90 includes a downtube 140 that extends from the headtube 74 to an opposite end 142 that is pivotably coupled to a base member 144 of the neck assembly 90 with a connector bolt 146. The connector bolt 146 defines the hinge joint 20. Specifically, the downtube 140 is positioned between a pair of upstanding sidewalls or brackets 148 of the base member 144. The upstanding brackets 148 are spaced apart and extend upward from a tubular body 150 of the base member 144, forming a generally U-shaped configuration for the base member 144. The downtube 140 is secured between the upstanding brackets 148 with the connector bolt 146, allowing the downtube 140 to pivot relative to the base member 144 within the space between the upstanding brackets 148.

The scooter 10 may be locked in either the upstanding position or the collapsed position. In that regard, the neck assembly 90 includes a locking mechanism 152 configured to lock the neck assembly 90 in the desired position to thereby prevent unintended movement of the scooter 10 from the desired position. As best shown in FIGS. 3 and 4, the locking mechanism 152 is integrated into the downtube 140 of the neck assembly 90 and includes a lever 154 for selectively actuating the locking mechanism 152. The lever 154 is positioned externally on the downtube 140. The lever 154 operates by moving a latch pin 156 into or out of respective pairs of notches 158 formed in the upstanding brackets 148 of the base member 144. In that regard, a spring 160 is connected between the latch pin 156 and the connector bolt 146, biasing the latch pin 156 into engagement with the corresponding pair of notches 158. By lifting the lever 154, the biasing force of the spring 160 is overcome, thereby withdrawing the latch pin 156 from the notches 158 and allowing the neck assembly 90 to pivot (i.e., fold) about the hinge joint 20. When the latch pin 156 is engaged with the front-most pair of notches 158, the scooter 10 is locked in the upstanding position. Conversely, when the latch pin 156 is engaged with the rear-most pair of notches 158, the scooter 10 is secured in the collapsed position. To retain the scooter 10 firmly in either position, the latch pin 156 may take the form of a compression lock pin, featuring a cam lever or other mechanism to enhance secure engagement within the notches 158 to prevent accidental disengagement of the latch pin 156 during use.

With continued reference to FIGS. 3 and 4, the tubular body 150 of the base member 144 is configured to receive the terminal end 112 of the deck tube 110, thereby coupling the neck assembly 90 to the rear wheel assembly 92, as briefly described above. Specifically, the terminal end 112 of the deck tube 110 is inserted into the tubular body 150 of the base member 144 and secured with the pair of fasteners 114. The fasteners 114, which may be bolts or screws, are threaded through apertures in the tubular body 110 located on the underside of the scooter 10 and into corresponding apertures in the terminal end 112 of the deck tube 110, ensuring a secure connection between the deck tube 110 and the neck assembly 90. Additionally, the neck assembly 90 may include a cap or plug 166 that is configured to cover and seal the open ends of both the tubular body 150 of the base member 144 and the deck tube 110. The cap 166 is configured to be received into the terminal end 112 of the deck tube 110, as shown. The cap 166 may be secured in place with one of the fasteners 114.

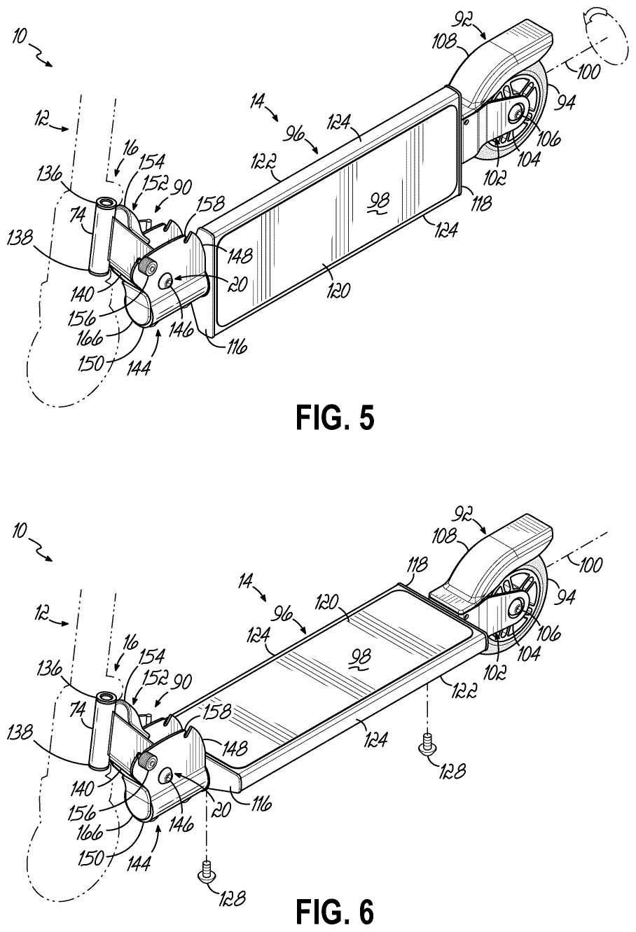

Referring now to FIGS. 5 and 6, rotation of the deck 96 relative to the rear frame 14 will now be described in further detail. The deck 96 is configured to rotate about the deck axis 100 and the deck tube 110 in either a clockwise or counterclockwise direction. With the fasteners 128 removed, the deck 96 may freely rotate or spin in either direction about the deck tube 110, for example. The deck 96 may be rotated to the stowed position, as shown in FIG. 5, for storage or packaging purposes. In that regard, as the deck 96 is rotated to the stowed position from another position, such as e.g., the operative position, the rotational movement causes one side edge 124 to rise upward, while the opposite side edge 124 begins to descend. As this tilting of the deck 96 progresses, the support surface 98 plane of the deck 96 gradually moves toward a vertical orientation. When in the stowed position, as shown in FIG. 5, the deck 96 is upright or vertical, with the support surface 98 plane of the deck 96 being approximately perpendicular to the ground. That is, the support surface 98 plane is non-horizontal when the deck 96 is in the stowed position. The side edges 124 of the deck 96 are vertically separated and aligned in a stacked position, with one edge 124 being positioned directly above the other. The side edges 124 occupy a top-and-bottom relationship, and the vertical separation between the side edges 124 is equal to the width of the deck 96.

The deck 96 is rotated approximately 90° from the stowed position to the operative position, shown in FIG. 6, and vice versa. In that regard, as the deck 96 is rotated from the stowed position, the topmost side edge 124 starts to descend downward while the opposite, bottommost side edge 124 begins to rise upward. The side edges 124 gradually separate from their vertical alignment, and the support surface 98 plane of the deck 96 is rotated from a vertical orientation to horizontal orientation. During this motion, the deck 96 passes through an intermediate tilted orientation where the side edges 124 are neither perfectly aligned vertically nor horizontally. When rotated to the operative position, the support surface 98 plane of the deck 96 is approximately horizontal to the ground, and generally level, with the two side edges 124 aligned next to each other within the same horizontal plane. That is, the side edges 124 may be positioned at the same height relative to the ground. When in the operative position, the support surface 98 plane may be generally perpendicular to the steering axis 18, for example. The deck 96 may be secured in the operative position with the fasteners 128, as described above.

In the embodiment shown, the deck tube 110 includes a circular cross-sectional profile. However, in an alternative embodiment, the fork stem of the rear fork 102 (i.e., deck tube 110) may include non-circular cross-sectional profiles, such as a square profile, for example. In this alternative embodiment, the deck 96 may be removed from the deck tube 110, rotated, and reattached to the deck tube 110 to facilitate rotating the deck 96 between the operative position and the stowed position. Accordingly, the term “tube” should not be construed as being limited to a circular cross-sectional profile.

The ability to selectively rotate the deck 96 to the stowed position offers significant advantages in terms of space-efficient packaging of the scooter 10. In that regard, and with reference to FIGS. 7-9, a method for packaging the scooter 10 in a carton 170 is shown and will now be described. The carton 170, also referred to in the industry as a box, container, package, case, packaging unit, or shipping unit, is configured to securely enclose and retain the scooter 10 for both shipping and display in shelving units for sale. As a result of the space-efficient packaging provided by the scooter 10, the carton 170 may be configured as a peggable carton, enhancing its versatility for retail display purposes. A peggable carton is a type of packaging having a perforated or pre-punched hole at the top or side, allowing it to be hung on a display peg or hook.

As shown in FIGS. 7-9, the carton 170 includes a length L dimension, a width W dimension, and a height H dimension. The length L dimension is measured along the longest side of the carton 170 between ends of the carton 170. The width W dimension is the shorter side of the carton 170 that is perpendicular to the length L of the carton 170. The width dimension defines the depth or breadth of the carton 170 and is often considered when determining how multiple cartons 170 can be stacked on a shelving space or hung from a shelving peg. The height H dimension is the vertical dimension of the carton 170 when it is placed upright in its standard orientation. The height H measurement represents the distance from the base to the top of the carton 170.

FIG. 7 is a top view of the scooter 10 packaged in a carton 170, with the scooter 10 folded into the collapsed position and the deck 96 rotated to the stowed position. This arrangement of the scooter 10 is referred to as the packaged configuration. FIG. 8 is a top view of the scooter 10 packaged within a different, larger carton 172, with the scooter 10 folded into the collapsed position but with the deck 96 rotated to the operative position. As shown, rotating the deck 96 to the stowed position allows the width dimension W1 of the carton 170 to be reduced compared to the width dimension W2 of the larger carton 172, thereby decreasing the overall size and footprint of the carton 170 required to package the scooter 10. For example, the width dimension W1 of the carton 170 may be 60 mm as compared to the width dimension W2 of the larger carton 172, which may be 105 mm.

As shown in FIG. 7, the width dimension W1 of the carton 170 is no longer dictated by the width of the deck 96 of the scooter 10. As the depth of the deck 96 (measured from the base 122 to top 120 of the deck 96) is less than the width of the deck 96 and the outermost components of the scooter 10, the width dimension W1 of the carton 170 may instead be dictated by other components of the scooter 10, such as the neck assembly 90, for example. In any case, the ability to rotate the deck 96 to the stowed position not only optimizes packaging material usage but also facilitates more efficient transportation and storage. Consequently, more cartons 170 may be shipped together and stored on shelves for retail display purposes.

FIG. 9 is a schematic side view of the packaged scooter 10 shown in FIG. 7, illustrating additional details of the packaged configuration of the scooter 10. As shown, the scooter 10 may be secured to a backing panel or insert panel 174 using one or more tie-downs or straps 176. The backing panel 174 may then be inserted into the carton 170. Alternatively, the scooter 10 may be directly attached to a wall of the carton 170 using tie-downs 176 or similar means, or placed into a plastic molded insert or tray that is inserted into the carton 170.

To prepare the scooter 10 for packaging, as shown in FIG. 9, the scooter 10 is folded at the hinge joint 20 and locked in the collapsed position. Either before or after this step, the deck 96 is rotated about the deck tube 110 to place the deck 96 in the stowed position. When in the packaged configuration, the scooter 10 may then be attached to the backing panel 174, as shown. When attached to the backing panel 174, in the packaged configuration, the support surface 98 plane of the deck 96 is generally parallel to a plane defined by the backing panel 174. Further, the steering tube 32 is approximately parallel to the deck tube 110, and at least one of the pair of side edges 124 is positioned between the steering tube 32 and the deck tube 110. The handlebar 22 is arranged in the space between the steering tube 32 and the deck 96 of the scooter 10 and is secured to the backing panel 174 with one or more tie-downs 176. Specifically, the handlebar 22 is positioned between one side edge 124 of the deck 96 and the steering tube 32 of the front frame 12. Once the scooter 10 is attached to the backing panel 176, as shown, the backing panel 176 is inserted into the carton 170.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A scooter, comprising:
a front frame assembly comprising a handlebar connected to a steering tube that includes a front wheel supported by a front fork; and
a rear frame assembly, comprising:
a neck assembly including a head tube, the steering tube being rotatably coupled to the head tube to define a steering axis about which the front frame rotates relative to the rear frame;
a rear wheel assembly including a rear wheel supported by a rear fork and a deck tube that extends a length from the rear fork to a terminal end, the terminal end of the deck tube being attached to the neck assembly; and
a deck supported by the deck tube;
wherein the deck is selectively rotatable about the deck tube between at least an operative position wherein the deck is configured to support a rider and a stowed position.

2. The scooter of claim 1, wherein the deck includes a support surface that is configured to receive the rider, the support surface defining a support surface plane, wherein the support surface plane is horizontal when the deck is rotated to the operative position, and the support surface plane is non-horizontal when the deck is rotated to the stowed position.

3. The scooter of claim 1, wherein the deck is secured in the operative position with one or more fasteners received through the deck and the deck tube.

4. The scooter of claim 1, wherein the deck tube extends along a length of the deck.

5. The scooter of claim 1, wherein the deck tube includes a circular cross-sectional profile.

6. The scooter of claim 1, wherein the deck extends a length between a first end and an opposite second end, the deck including a channel that extends from an opening at the first end of the deck to an opening at the second end of the deck, wherein the deck tube is received through the channel.

7. The scooter of claim 4, wherein the channel defines a bore through the deck.

8. The scooter of claim 1, wherein the head tube of the neck assembly is arranged externally along a sidewall of the steering tube.

9. The scooter of claim 1, wherein the steering tube defines a steering tube axis, the steering tube axis being offset from the steering axis.

10. The scooter of claim 1, wherein the steering axis is located outside the steering tube.

11. The scooter of claim 1, wherein the neck assembly is selectively foldable about a hinge joint to place the scooter in at least an upright position, wherein the steering tube is approximately perpendicular to the deck tube, and a collapsed position, wherein the steering tube is approximately parallel to the deck tube.

12. The scooter of claim 11, wherein the deck is selectively rotatable to the stowed position when the scooter is in the collapsed position.

13. A method for packaging a scooter, comprising:
providing a carton;
providing the scooter, comprising:
a front frame assembly comprising a handlebar, a steering tube, and a front wheel supported by a front fork; and
a rear frame assembly, comprising:
a neck assembly operatively coupled to the front frame assembly such that the front frame assembly is rotatable about a steering axis relative to the rear frame assembly, the neck assembly being selectively foldable about a hinge joint;
a rear wheel assembly including a rear wheel supported by a rear fork and a deck tube that extends a length from the rear fork to a terminal end, the terminal end of the deck tube being attached to the neck assembly; and
a deck supported by the deck tube, the deck being rotatable relative to the deck tube;
assembling the scooter into a packaged configuration, comprising:
folding the scooter at the hinge joint to place the scooter in a collapsed position; and
rotating the deck about the deck tube to place the deck in a stowed position; and
inserting the scooter into the carton once the scooter is assembled to the packaged configuration.

14. The method of claim 13, wherein the steering tube is approximately parallel to the deck tube when the scooter is in the packaged configuration.

15. The method of claim 13, wherein the deck extends a width between a pair of side edges that extend along a length of the deck, wherein when the scooter is in the packaged configuration at least one of the pair of side edges is disposed in a space between the steering tube and the deck tube.

16. The method of claim 13, wherein assembling the scooter into the packaged configuration further comprises:
placing the handlebar in a space between the steering tube and the deck of the scooter.

17. The method of claim 16, wherein the deck extends a width between a pair of side edges that extend along a length of the deck, wherein when the scooter is in the packaged configuration the handlebar is arranged between at least one of the pair of side edges and the steering tube.

18. The method of claim 13, further comprising:
attaching the scooter to a backing panel wherein the scooter is maintained in the packaged configuration by the backing panel; and
inserting the backing panel and the scooter into the carton.

19. The method of claim 18, wherein the deck includes a support surface that is configured to receive the rider, the support surface defining a support surface plane, wherein the support surface plane is approximately parallel to a plane defined by the backing panel when the scooter is attached to the backing panel.

20. The method of claim 13, wherein the carton is a peggable carton.
